(19) United States
(12) Patent Application Publication
(10) Pub. No.: US 2026/0295776 A1
(43) Pub. Date: Oct. 1, 2026

(54) A Double-force Pneumatic Vice

(71) Applicant: Shenzhen Fushijie Intelligent Robot Co., Ltd., Shenzhen, Guangdong (CN)

(72) Inventor: Xuehong Liu, Shenzhen, Guangdong (CN)

(21) Appl. No.: 19/129,633

(22) PCT Filed: Sep. 25, 2023
(86) PCT No.: PCT/CN2023/121133

§ 371 Date: May 19, 2025

(30) Foreign Application Priority Data
Nov. 18, 2022 (CN) 202211445422.0

(51) Int. Cl. B25B 1/18; B25B 1/02; B25B 1/10

(52) U.S. Cl. CPC B25B 1/18; B25B 1/02; B25B 1/103; B25B 1/106

(57) ABSTRACT

The present invention discloses a double-force pneumatic vice, belonging to the field of mechanical processing tools, comprising a vice body, a fixed vice jaw is securely connected to a right side of an upper end of the vice body, a double-force cylinder is securely installed on a right end of the vice body, the upper end of the vice body is provided with a placement groove in which a lead screw is securely installed, and the lead screw passes through the vice body and is securely connected to the double-force cylinder; the left side of the upper end of vice body is slidably connected with a movable vice jaw and a sliding block, and the movable vice jaw and the sliding block are fixedly connected, the double-force cylinder supplies power so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.

### TECHNICAL FIELD

The present invention relates to the field of mechanical processing tools, and more specifically, to a double-force hydraulic vice.

### BACKGROUND

vices are a commonly used auxiliary tool in the field of mechanical processing, used to clamp workpieces. The existing vices can adjust the distance between the movable vice jaw and the fixed vice jaw by rotating the screw during application, thus clamping workpieces. However, it is necessary to loosen the lead screw when the processed workpiece needs to be replaced with a new one, and disassembling and installing workpieces by frequent manual rotation of the lead screw in the continuous production process result in low work efficiency and high labor intensity for operators.

The double-force vice is characterized by its complete elimination of the transmission oil pressure system, so it will not suffer from pressure loss due to oil leakage or will not need frequent maintenance due to oil seal aging and wear, and it can quickly increase pressure without pressure loss.

During the use of the vice, the movable vice jaw is usually in contact with three sides of the vice base, the frequent movement of movable vice jaw towards the fixed vice jaw causes damage to the contact surface between the end of the movable vice jaw close to the fixed vice jaw and the vice base, and loose fit occurs between the movable vice jaw and the vice base; when the vice clamps a workpiece, due to the force exerted by the lead screw on the movable vice jaw, the movable vice jaw tilts upward relative to the vice base, far away from its force-bearing side, causing interference with the upper cover of the vice and making it difficult to clamp the workpiece and, in further, the workpiece is more likely to be pulled up during processing.

### SUMMARY

### 1. Technical Problems to be Addressed

In response to the problems in the existing technology, the present invention aims to provide a double-force hydraulic vice powered by a double-force cylinder, so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.

### 2. Technical Solution

To solve the above problems, the present invention adopts the following technical solution.

A double-force vice, comprising a vice body, a fixed vice jaw is securely connected to a right side of an upper end of the vice body, a double-force cylinder is securely installed on a right end of the vice body, the upper end of the vice body is provided with a placement groove in which a lead screw is securely installed, and the lead screw passes through the vice body and is securely connected to the double-force cylinder; the left side of the upper end of vice body is slidably connected with a movable vice jaw and a sliding block, and the movable vice jaw and the sliding block are fixedly connected, the outer end of the lead screw is threaded with a lead screw nut that is fixedly connected to the sliding block, the left end of the vice body is fixedly installed with a manifold, and the upper end of the manifold is fixedly installed with a pressure regulating valve, a first control valve, a second control valve, and a third control valve, and the first control valve, the second control valve, and the third control valve are fixedly connected to each other, the upper ends of the first control valve, the second control valve, and the third control valve are fixedly connected to the pressure regulating valve through an air tube, and the lower end of the first control valve is connected to the manifold through the air tube, and the double-force cylinder supplies power so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.

In further, an end of the lead screw close to the double-force cylinder is rotatably connected with a connecting block, and an end of the connecting block far away from the lead screw is threaded with an anti loosening lead screw, the lead screw is connected to the double-force cylinder through a connecting block, and the anti loosening lead screw can prevent the lead screw from falling off.

In further, one end of the lead screw far away from the connecting block is rotatably connected with a lead screw limit block that effectively limits the lead screw to prevent deviation from the track.

In further, the double-force cylinder comprises a first quick connector, a second quick connector, a third quick connector, and a fourth quick connector, and the first quick connector, the second quick connector, the third quick connector, and the fourth quick connector are fixedly connected to a side end of the double-force cylinder, respectively, and multiple quick connectors can be connected according to needs.

In further, the double-force cylinder further comprises a piston rod, and a front end cover fixedly connecting to the vice body, the piston rod is fixedly connected to the front end cover, an end of the piston rod far away from the front end cover is fixedly connected with a piston rod sealing ring, an end of the piston rod way from the front end cover is threaded with a pull rod screw, and an end of the pull rod screw far away from the front end cover is fixedly connected with a rear end cover, and a rear cylinder, a middle cylinder and a middle end cover are fixedly installed between the front end cover and the rear end cover, and a rear end piston and a middle piston are installed among the rear cylinder, middle cylinder, and rear end cover, respectively, and a middle cushion cover is fixedly installed between the rear end piston and the middle piston.

In further, the double-force cylinder further comprises an O-ring seal and a middle end cover, and the O-ring seal and the middle end cover are fixedly installed between the rear cylinder, the middle cylinder, and the rear end piston, respectively, and the rear cylinder barrel and the middle cylinder barrel wrap around the piston part for movement, while the rear end piston provides effective sealing performance to prevent the double-force cylinder from leaking.

In further, an end of the rear end piston close to the middle piston is fixedly connected with a piston sealing ring, and the sealing effect provided by the piston sealing ring can make the pressure inside the double-force cylinder more sufficient and the power more abundant.

In further, the pressure regulating valve comprises a fifth quick connector fixedly connecting to an upper end of the pressure regulating valve, and a sixth quick connector fixedly connecting to a lower end of the pressure regulating valve, and the fifth connector and sixth quick connector can be connected by a air tube to control the pressure regulating valve.

In further, the lower end of the lead screw nut fits the placement groove, and the sliding between the lead screw nut and the placement groove can prevent mutual friction.

### 3. Beneficial Effects

Compared to prior art, the present invention has the following advantages:
(1) In the solution, the double-force cylinder supplies power so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.
(2) In the solution, an end of the lead screw close to the double-force cylinder is rotatably connected with a connecting block, and an end of the connecting block far away from the lead screw is threaded with an anti loosening lead screw, the lead screw is connected to the double-force cylinder through a connecting block, and the anti loosening lead screw can prevent the lead screw from falling off.
(3) In the solution, one end of the lead screw far away from the connecting block is rotatably connected with a lead screw limit block that effectively limits the lead screw to prevent deviation from the track.
(4) In the solution, the double-force cylinder comprises a first quick connector, a second quick connector, a third quick connector, and a fourth quick connector, and the first quick connector, the second quick connector, the third quick connector, and the fourth quick connector are fixedly connected to a side end of the double-force cylinder, respectively, and multiple quick connectors can be connected according to needs.

The double-force cylinder further comprises a piston rod, and a front end cover fixedly connecting to the vice body, the piston rod is fixedly connected to the front end cover, an end of the piston rod far away from the front end cover is fixedly connected with a piston rod sealing ring, an end of the piston rod way from the front end cover is threaded with a pull rod screw, and an end of the pull rod screw far away from the front end cover is fixedly connected with a rear end cover, and a rear cylinder, a middle cylinder and a rear end piston are fixedly installed between the piston rods, and a rear end piston and a middle piston are installed among the rear cylinder, middle cylinder, and rear end piston, respectively, and a middle cushion cover is fixedly installed between the rear end piston and the middle piston, and the double-force cylinder, through internal operation, provides power to enable lead screw to drive the movement of movable vice jaw; the double-force cylinder further comprises an O-ring seal and a middle end cover, and the O-ring seal and the middle end cover are fixedly installed between the rear cylinder, the middle cylinder, and the rear end piston, respectively, the rear cylinder barrel and the middle cylinder barrel wrap around the piston part for movement, while the rear end piston provides effective sealing performance to prevent the double-force cylinder from leaking; an end of the rear end piston close to the middle piston is fixedly connected with a piston sealing ring, and the sealing effect provided by the piston sealing ring can make the pressure inside the double-force cylinder more sufficient and the power more abundant.
(5) In the solution, the pressure regulating valve comprises a fifth quick connector fixedly connecting to an upper end of the pressure regulating valve, and a sixth quick connector fixedly connecting to a lower end of the pressure regulating valve, and the fifth connector and sixth quick connector can be connected by a air tube to control the pressure regulating valve.
(6) In the solution, the lower end of the lead screw nut fits the placement groove, and the sliding between the lead screw nut and the placement groove can prevent mutual friction.

### BRIEF DESCRIPTION OF THE DRAWINGS

FIG. 1 is a schematic diagram of the overall structure of the present invention;

FIG. 2 is a schematic diagram of the exploded structure of the present invention;

FIG. 3 is a structural diagram of the double-force cylinder of the present invention.

The numbering in the figure:

1. vice body; 2. Fixed vice jaw; 3. double-force cylinder; 31. First quick connector; 32. Second quick connector; 33. Third quick connector; 34. Fourth quick connector; 35. Piston rod; 36. Front end cover; 37. Piston rod sealing ring; 38. O-ring seal; 39. Middle end cover; 310. Pull rod screw; 311. Rear end cover; 312. Rear cylinder barrel; 313. Middle cylinder barrel; 314. Rear end piston; 315. Piston sealing ring; 316. Middle piston; 317. Middle cushion sleeve; 4. Anti loosening lead screw; 5. Connecting block; 6. Lead screw; 7. Movable vice jaw; 8. sliding block; 9. Lead screw nut; 10. Lead screw limit block; 11. Pressure regulating valve; 111. Fifth quick connector; 112. Sixth quick connector; 12. Manifold; 13. Air tube; 14. First control valve; 15. Second control valve; 16. Third control valve.

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In the description of the present invention, it should be noted that the terms “up”, “down”, “inside”, “outside”, “top/bottom”, etc. indicate orientation or position relationships based on the orientation or position relationships shown in the accompanying drawings, only for the convenience of describing the present invention and simplifying the description, and do not indicate or imply that the device or element referred to must have a specific orientation, be constructed and operated in a specific orientation, and therefore cannot be understood as limiting the present invention. In addition, the terms “first” and “second” are only used for descriptive purposes and cannot be understood as indicating or implying relative importance.

In the description of the present invention, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two components. The person having ordinary skill in the art can understand the specific meanings of the above terms in the present invention in specific situations.

### Example 1

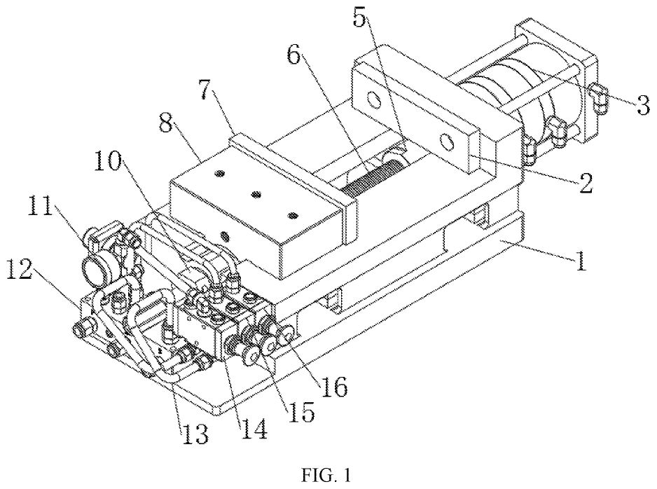

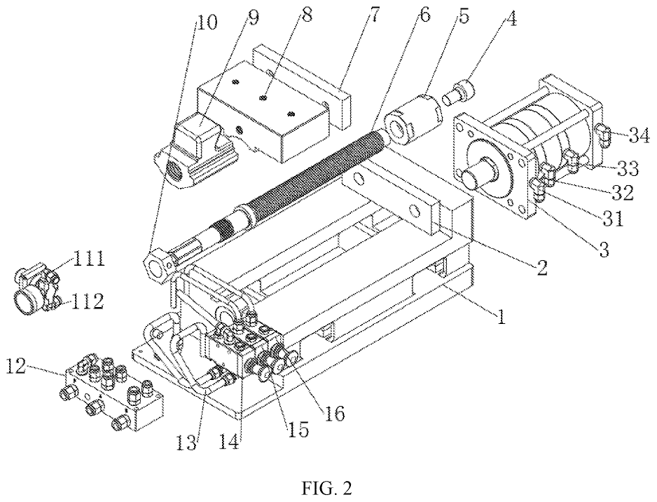

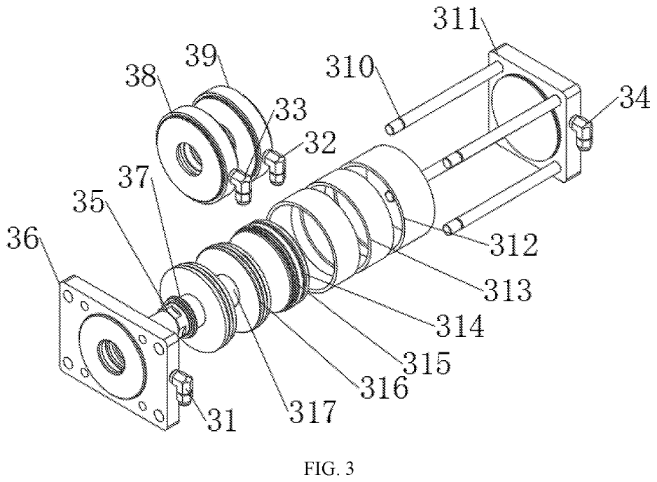

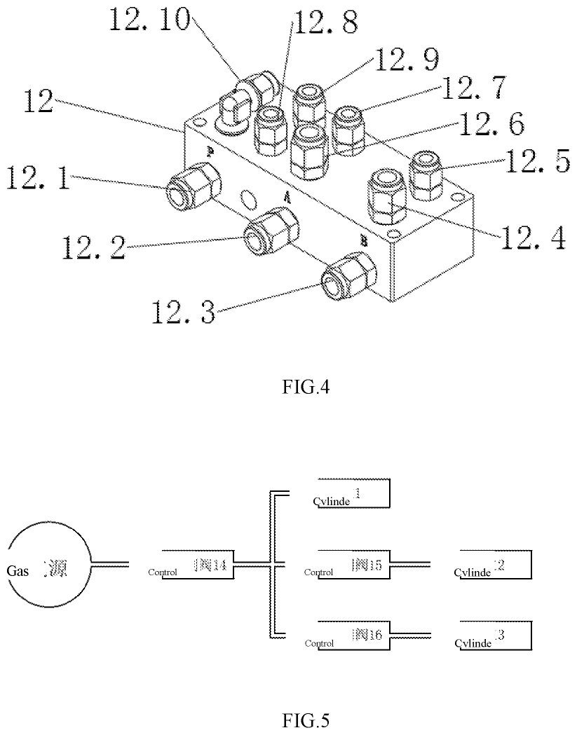

As shown in FIG. 1-3, a double-force vice, comprising a vice body 1, wherein a fixed vice jaw 2 is securely connected to a right side of an upper end of the vice body 1, a double-force cylinder 3 is securely installed on a right end of the vice body 1, the upper end of the vice body 1 is provided with a placement groove in which a lead screw 6 is securely installed, and the lead screw 6 passes through the vice body 1 and is securely connected to the double-force cylinder 3; the left side of the upper end of vice body 1 is slidably connected with a movable vice jaw 7 and a sliding block 8, and the movable vice jaw 7 and the sliding block 8 are fixedly connected, the outer end of the lead screw 6 is threaded with a lead screw nut 9 that is fixedly connected to the sliding block 8, the left end of the vice body 1 is fixedly installed with a manifold 12, and the upper end of the manifold 12 is fixedly installed with a pressure regulating valve 11, a first control valve 14, a second control valve 15, and a third control valve 16, and the first control valve 14, the second control valve 15, and the third control valve 16 are fixedly connected to each other, the upper ends of the first control valve 14, the second control valve 15, and the third control valve 16 are fixedly connected to the pressure regulating valve 11 through an air tube, and the lower end of the first control valve 14 is connected to the manifold 12 through the air tube 13, and the double-force cylinder supplies power so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.

An end of the lead screw 6 close to the double-force cylinder 3 is rotatably connected with a connecting block 5, and an end of the connecting block 5 far away from the lead screw 6 is threaded with an anti loosening lead screw 4, the lead screw is connected to the double-force cylinder through a connecting block, and the anti loosening lead screw can prevent the lead screw from falling off.

An end of the lead screw 6 far away from the connecting block 5 is rotatably connected with a lead screw limit block 10 that effectively limits the lead screw 6 to prevent deviation from the track.

The double-force cylinder 3 comprises a first quick connector 31, a second quick connector 32, a third quick connector 33, and a fourth quick connector 34, and the first quick connector 31, the second quick connector 32, the third quick connector 33, and the fourth quick connector 34 are fixedly connected to a side end of the double-force cylinder 3, respectively, and multiple quick connectors can be connected according to needs.

The double-force cylinder 3 further comprises a piston rod 35, and a front end cover 36 fixedly connecting to the vice body 1, the piston rod 35 is fixedly connected to the front end cover 36, an end of the piston rod 35 far away from the front end cover 36 is fixedly connected with a piston rod sealing ring 37, an end of the piston rod 35 way from the front end cover 36 is threaded with a pull rod screw 310, and an end of the pull rod screw 310 far away from the front end cover 36 is fixedly connected with a rear end cover 311, and a rear cylinder 312, a middle cylinder 313 and a rear end piston 314 are fixedly installed between the piston rods 35, and a rear end piston 314 and a middle piston 316 are installed among the rear cylinder 312, middle cylinder 313, and rear end piston 314, respectively, and a middle cushion cover 317 is fixedly installed between the rear end piston 314 and the middle piston 316, and the double-force cylinder 3, through internal operation, provides power to enable lead screw 6 to drive the movement of movable vice jaw 7.

The double-force cylinder 3 further comprises an O-ring seal 38 and a middle end cover 39, and the O-ring seal 38 and the middle end cover 39 are fixedly installed between the rear cylinder 312, the middle cylinder 313, and the rear end piston 314, respectively, and the rear cylinder barrel 312 and the middle cylinder barrel 313 wrap around the piston part for movement, while the rear end piston 314 provides effective sealing performance to prevent the double-force cylinder 3 from leaking, an end of the rear end piston 314 close to the middle piston 316 is fixedly connected with a piston sealing ring 315, and the sealing effect provided by the piston sealing ring 315 can make the pressure inside the double-force cylinder 3 more sufficient and the power more abundant.

The pressure regulating valve 11 comprises a fifth quick connector 111 fixedly connecting to an upper end of the pressure regulating valve 11, and a sixth quick connector 112 fixedly connecting to a lower end of the pressure regulating valve 11, and the fifth connector 111 and sixth quick connector 112 can be connected by a air tube 13 to control the pressure regulating valve 11.

The lower end of the lead screw nut 9 fits the placement groove, and the sliding between the lead screw nut 9 and the placement groove can prevent mutual friction. In the present invention, a double-force cylinder supplies power so that the lead screw drives the movable vice jaw to move towards the fixed vice jaw to clamp and fix the workpiece, the double-force cylinder is controlled by a control valve so that the lead screw nut, which is driven by the rotating lead screw, drives the sliding block to move, and further makes the movable vice jaw move and clamp the workpiece along with the pipe vice jaw, therefore the looseness between the movable vice jaw and the vice body can be effectively prevented, and also the workpiece can be more firmly clamped to avoid the workpiece being pulled up.

The scope of protection of the present invention is not limited to the above embodiments, which are merely the preferred ones, of the present invention. Any equivalent substitution or change made by any person skilled in the art within the technical scope disclosed in the present invention based on the technical solution and its improved concept of the present invention shall be covered within the scope of protection hereof.

1. A double-force vice, comprising a vice body (1), wherein a fixed vice jaw (2) is securely connected to a right side of an upper end of the vice body (1), a double-force cylinder (3) is securely installed on a right end of the vice body (1), the upper end of the vice body (1) is provided with a placement groove in which a lead screw (6) is securely installed, and the lead screw (6) passes through the vice body (1) and is securely connected to the double-force cylinder (3); the left side of the upper end of vice body (1) is slidably connected with a movable vice jaw (7) and a sliding block (8), and the movable vice jaw (7) and the sliding block (8) are fixedly connected, the outer end of the lead screw (6) is threaded with a lead screw nut (9) that is fixedly connected to the sliding block (8), the left end of the vice body (1) is fixedly installed with a manifold (12), and the upper end of the manifold (12) is fixedly installed with a pressure regulating valve (11), a first control valve (14), a second control valve (15), and a third control valve (16), and the first control valve (14), the second control valve (15), and the third control valve (16) are fixedly connected to each other, the upper ends of the first control valve (14), the second control valve (15), and the third control valve (16) are fixedly connected to the pressure regulating valve (11) through an air tube, and the lower end of the first control valve (14) is connected to the manifold (12) through the air tube (13).

2. The double-force hydraulic vice according to claim 1, wherein an end of the lead screw (6) close to the double-force cylinder (3) is rotatably connected with a connecting block (5), and an end of the connecting block (5) far away from the lead screw (6) is threaded with an anti loosening lead screw (4).

3. The double-force hydraulic vice according to claim 1, wherein one end of the lead screw (6) far away from the connecting block (5) is rotatably connected with a lead screw limit block (10).

4. The double-force hydraulic vice according to claim 1, wherein the double-force cylinder (3) comprises a first quick connector (31), a second quick connector (32), a third quick connector (33), and a fourth quick connector (34), and the first quick connector (31), the second quick connector (32), the third quick connector (33), and the fourth quick connector (34) are fixedly connected to a side end of the double-force cylinder (3), respectively.

5. The double-force hydraulic vice according to claim 1, wherein the double-force cylinder (3) further comprises a piston rod (35), and a front end cover (36) fixedly connecting to the vice body (1), the piston rod (35) is fixedly connected to the front end cover (36), an end of the piston rod (35) far away from the front end cover (36) is fixedly connected with a piston rod sealing ring (37), an end of the piston rod (35) way from the front end cover (36) is threaded with a pull rod screw (310), and an end of the pull rod screw (310) far away from the front end cover (36) is fixedly connected with a rear end cover (311), and a rear cylinder (312), a middle cylinder (313) and a middle end cover (39) are fixedly installed between the front end cover (36) and the rear end cover (311), and a rear end piston (314) and a middle piston (316) are installed among the rear cylinder (312), middle cylinder (313), and rear end cover (311), respectively, and a middle cushion cover (317) is fixedly installed between the rear end piston (314) and the middle piston (316).

6. The double-force hydraulic vice according to claim 1, wherein the double-force cylinder (3) further comprises an O-ring seal (38) and a middle end cover (39), and the O-ring seal (38) and the middle end cover (39) are fixedly installed between the rear cylinder (312), the middle cylinder (313), and the rear end piston (314), respectively.

7. The double-force hydraulic vice according to claim 5, wherein an end of the rear end piston (314) close to the middle piston (316) is fixedly connected with a piston sealing ring (315).

8. The double-force hydraulic vice according to claim 1, wherein the pressure regulating valve (11) comprises a fifth quick connector (111) fixedly connecting to an upper end of the pressure regulating valve (11), and a sixth quick connector (112) fixedly connecting to a lower end of the pressure regulating valve (11).

9. The double-force hydraulic vice according to claim 1, wherein the lower end of the lead screw nut (9) fits the placement groove.
